(19) United States
(12) Patent Application Publication
(10) Pub. No.: US 2026/0247315 A1
(43) Pub. Date: Aug. 20, 2026

(54) Timing Adjustments Relating to Wireless Communications

(71) Applicant: Telefonaktiebolaget LM Ericsson (publ), Stockholm (SE)

(72) Inventors: Min Wang, Luleå (SE); Ming Li, Stockholm (SE)

(21) Appl. No.: 19/471,936

(22) PCT Filed: Feb. 13, 2024
(86) PCT No.: PCT/SE2024/050127

§ 371 Date: Oct. 2, 2025

Related U.S. Application Data
(60) Provisional application No. 63/457,249, filed on Apr. 5, 2023.

(51) Int. Cl. H04W 56/00; H04B 7/06; H04W 74/0833; H04W 80/02

(52) U.S. Cl. CPC H04W 56/0045; H04B 7/06968; H04W 74/0833; H04W 80/02

(57) ABSTRACT

Methods and apparatuses for adjusting timing of a user equipment, UE, with respect to a serving cell in a wireless network An example method comprises receiving (810) from the wireless network, in or associated with a message or command changing an active configuration of the UE, an indication of whether the change in active configuration of the UE corresponds to one or both of (i) a change in Remote Radio Head, RRH, or transmission point(s), TRP(s), for transmissions from the wireless network to the UE and (ii) a change in uplink, UL, transmit timing and/or timing advance, TA, for the UE that exceeds the UE's capability to track with gradual timing adjustment procedures specified for the UE. The example method further comprises performing (820) one or more timing-adjustment operations, based on the indication.

### TECHNICAL FIELD

The present disclosure is generally related to wireless communications and is more particularly related to improving techniques for timing adjustments, e.g., in a high-speed travel environment.

### BACKGROUND

A goal of specifications for 5G wireless systems under development by members of the 3rd-Generation Partnership Project (3GPP) is support for operation of user equipment (“UEs”—3GPP terminology for end user terminals) in high-speed environments, e.g., while onboard a moving train. Thus, the High-Speed Train, or HST, scenario is a key use case for standardization.

Following the creation of Rel-15 UE specifications for 300 km/h operation, dedicated HST work for NR (the radio access network, RAN, technology for 5G systems) in the frequency bands referred to as “FR1” started in the development of the Release 16 (Rel-16) version of the 3GPP specifications. Rel-16 guarantees the fundamental mobility performance in FR1 bands below 3.6 GHz at train speeds up to 500 km/h, including cell search and handover among NR cells and handover between NR and LTE cells. Release 17 (Rel-17) of the 3GPP standards enhances the performance requirements in HST conditions, especially when the network configures carrier aggregation (CA).

The HST work for NR in the frequency bands referred to as “FR2” started with Rel-17. Rel-17 guarantees the fundamental mobility performance in FR2 bands below 30 GHz at speeds up to 350 km/h. Considering the radio propagation characteristics in high frequency bands, the FR2 HST scenario assumes the presence of dedicated UE installed on the rooftop of the train. Moreover, 3GPP has agreed to enhance the FR2 HST performance in Rel-18, including the CA scenario.

FR1 is generally capable of providing 5G coverage inside train carriages from outdoor base stations (BSs) that are either trackside or non-trackside. A trackside BS is defined as being within two meters of the track, while non-trackside BSs can be up to 150 meters away. Key challenges to HST operation in FR1 are securing performance with increased Doppler shift (particularly for mid-band time division duplex (TDD) frequencies), delivering good and consistent coverage, and ensuring seamless handover between BSs along the track.

To further improve coverage along the track, Single Frequency Network (SFN) can be deployed. In a SFN deployment, all the BS antennas—otherwise referred to as transmission and reception points (TRxPs)—have the same cell ID and transmit the same data from two or more TRxPs simultaneously.

To enable rapid switching of the serving TRxP, Dynamic Point Selection (DPS) can be used instead of simultaneous transmission in the SFN deployment. In this case, all TRxPs along the track have the same cell ID but only one TRxP transmits the data at a time. The serving TRxP is switched with transmission configuration indicator (TCI) switching, based on channel state information (CSI) reports from the UE.

Unlike FR1, the FR2 case assumes that a dedicated UE is mounted on the rooftop of the train to avoid penetration loss and that this UE provides separate links (e.g., using another radio interface such as WiFi) to serve users inside the train (e.g., train passengers and/or staff for train operation/communication) as a kind of mobile router. Operation in FR2 usually requires beam sweeping, where the UE/BS switches the transmitter (TX) and receiver (RX) beams to transmit/receive the signal, but this need is significantly reduced in the HST scenario. To reduce the amount of time it takes to search for the best TX/RX beam, it is assumed that the roof-mounted UE consists of two antenna panels; one RX beam pointing forward and the other RX beam pointing backward.

The radio link/interface (e.g., NR link) between the roof-mounted UE and the trackside base station (e.g., network node, access point RRH, etc.) and corresponding procedures are specified in the 3GPP specifications. A UE in this arrangement may be called an HST-dedicated UE, a customer-premises UE (CPE), etc. There may be different arrangements of the UE on the train, such as one UE per train providing service (e.g., internet services) to all the passengers and/or staff in the train, or one UE per train carriage, and so on. In some scenarios, the train speed can be up to 350 km/hour. In other scenarios, the train speed can be up to 500 km/hour or even larger.

Two deployment scenarios have been considered for BS deployment in FR2. In scenario A, the BS is trackside, and in scenario B, the BS is non-trackside. By covering these two scenarios, the specification enables FR2 deployments in any mixture of deployment scenarios. A given deployment is characterized by a physical distance/separation (Ds) between the successive base stations and a minimum/shortest distance (Dmin) between a base station and the track of the train as shown in FIG. 1. Table 1 shows some typical examples of Dmin and Ds.

TABLE 1
An example of HST deployment parameters

| Parameter | Value | Value |
|---|---|---|
| Dmin | 10 m | 150 m |
| Ds | 700 m | 700 m |

There are typically two main HST deployment scenarios namely “uni-directional” and “bi-directional.”

In uni-directional deployment, the antennas from all the base stations point the beams in the same direction along the track, as shown in FIG. 2. In FIG. 2, all the base stations, which are here shown as Remote Radio Heads (RRHs) transmit all the beams in the same direction—in this case, towards the right. In this example, RRH1 and RRH2 transmit different beams (SSB1, SSB2 from RRH1 and SSB3, SSB4 for RRH2) to cover different spatial directions. Based on the location of the UE, the UE may be served from the beams corresponding to SSB1 or SSB2 or SSB3 or SSB4. Note that a given base station might have multiple RRHs or TRxPs—for the purposes of this discussion these latter terms may be considered as interchangeable, unless their usage herein clearly indicates otherwise.

In a bi-directional deployment, as shown in FIG. 3, base stations are located along the track with antennas pointing in both directions. Base stations may transmit towards UEs from both directions and a UE receives the signals using a single frequency network (SFN) framework and/or a dynamic point switching (DPS) framework. In SFN, several transmitters (e.g., RRHs) simultaneously transmit the same signal or information over the same frequency channel. In dynamic point switching (DPS) the transmission from RRHs either switch dynamically between the different RRH points or are transmitted jointly from multiple RRH points.

The measurements (e.g., cell detection, RSRP, RSRQ, SINR, L1-RSRP, L1-SINR, etc.) performed by the UE comprise one or more samples or snapshots obtained at a sampling interval that depends on the UE implementation. The UE performs receive (RX) beam sweeping in different directions before taking a measurement sample. The UE typically uses a certain number of RX beams for beam sweeping, which may depend on the deployment scenario, e.g., 2 RX beams in a unidirectional deployment scenario and 6 RX beams in a bidirectional deployment scenario.

As specified in the 3GPP specification documents 3GPP TS 38.133 V18.0.0 (Section 7.1) and 3GPP TS 38.213 V17.5.0 (Section 4.2), Timing Advance (TA) is the advance in time a UE applies to its uplink (UL) transmissions relative to the timing at which the downlink (DL) frames (from the serving cell/RRH) are received. With the proper control of TA, the signal arrives at the base station (e.g., the NR gNB) receiver aligned with the start of the UL frame from the base station perspective. TA is essential for network operation and performance since it allows the base station to avoid the overlap of downlink Tx and uplink Rx in TDD, as well as for synchronizing the reception of multiple UE transmissions so that they arrive at the base station at the same time.

To control UL signal transmission timing at the UE, the Timing Advance adjustment Command (TAC) is used. The TAC is a MAC-CE based command used by the network to update the TA used by each UE, when needed. The base station, e.g., the NR gnB, constantly measures, tracks and indicates to the UE when to compensate for its time-varying propagation delay due to movement by sending TA updates to the UE. To estimate the amount of TA a UE needs, the gNB constantly measures the time of arrival of the received UL channels (e.g., PUSCH/PUCCH/SRS) compared to the actual start of the UL frame/slot.

The TAC can be indicated in two ways (3GPP TS 38.213 V17.5.0):
Through MAC-CE command in case UE is in RRC connected mode (associated to residual timing offset)
Through RAR (Random Access Response) as a part of the random access procedure (associated to initial timing offset).

In the case where the UE is in RRC connected state, the timing advance in seconds is defined as:

$$TA = {TA}_{old} + \frac{( TAC - 31 ) \cdot 16 \cdot 64}{{2}^{μ}} {T}_{c} ,$$

where TAC=0, 1, 2, . . . , 63; TA_{old} is the TA the UE is currently applying to its UL transmissions, μ is the numerology of the UL transmission and T_{c}=0.509 ns. In this case, since the TAC value can be as large as 63, six bits are needed to convey the TAC through MAC-CE. Thus, the TA adjustments that can be carried by TAC at 120 kHz SCS (μ=3) are in the range from −2.1 us to 2.1 μs, with 65 ns resolution.

In the case where the UE is performing the random access (RA) procedure, TA_{old} does not apply and the equation simplifies as:

$$TA = \frac{TAC \cdot 16 \cdot 64}{{2}^{μ}} {T}_{c} ,$$

where TA=0, 1, 2, . . . , 3846. In this case, the maximum TA that can be signaled with the RA procedure is up to 251 μs.

UL timing advance is applied by the UE to all UL transmissions (i.e., PUSCH, PUCCH, SRS) based on TAC from gNB. The UE initial transmission timing error shall be less than or equal to ±Te. The reference point for the UE initial transmit timing control requirement shall be the downlink timing of the reference cell minus

$$( {N}_{TA} + {N}_{TA offset} ) \times {T}_{c}$$

The downlink timing is defined as the time when the first detected path (in time) of the corresponding downlink frame is received from the reference cell. N_{TA} for PRACH is defined as 0. For FR2, 120 KHz SCS, Te=3.5*64*Tc=227.5*0.506 ns=115 ns.

When the transmission timing error between the UE and the reference timing exceeds ±Te then the UE is required to adjust its timing to within ±Te. The maximum aggregate adjustment rate shall be Tq per 200 ms. For FR2, 120 KHz SCS, Tq=4.5*32.552 ns=147 ns.

A UE is configured by a serving network node with one active TCI (transmission configuration indication) state for channel reception, e.g., PDCCH (physical downlink control channel) and PDSCH (physical downlink shared channel). The active TCI indicates, for each of the channels, a timing reference the UE shall assume for the downlink reception. The timing reference is defined with respect to a certain downlink reference signal (RS). Examples of RS are SSB, CSI-RS, DM-RS, PRS, etc. For example, the timing reference may be with respect to an SSB index associated with a particular transmit beam, or with respect to CSI-RS resource configured by the network node and provided (i.e., transmitted) to the UE.

A specific DL RS (e.g., SSB, CSI-RS) may be used as a proxy for referring to a DL beam, spatial filter, spatial domain transmission filter, main lobe of the radiation pattern of antenna array etc. Therefore, the active TCI state additionally indicates to the UE which UE Rx beam to use when receiving PDCCH and/or PDSCH, since it shall use the UE receive (RX) beam that allows best conditions for receiving the SSB index or DL-RS resource associated with the TCI state. The best UE RX beam for a given TCI state may change over time, for example, if the UE orientation changes, but also has to be relatively static at least over short time intervals.

Up to eight TCI states can be configured for PDSCH via higher layer signaling (RRC signaling), but only one TCI state can be active at any time. The active TCI state is used by the UE for receiving the channels, e.g., PDCCH and PDSCH. In case several TCI states are configured by the network node, the network node indicates to the UE via DCI (downlink control signaling over PDCCH) which one of the pre-configured TCI states to activate for upcoming PDSCH reception(s).

The active TCI state can be switched by the UE based on received command via MAC, DCI or RRC messages, etc. This is referred to as active TCI state switching. Upon receiving a TCI state command, the UE first sends HARQ feedback to the serving cell and switches to the active TCI state within a certain delay.

The RS or beams may be addressed or configured by an identifier, which can indicate the location of the beam in time in a beam pattern, e.g., a beam index such as SSB index indicate SSB beam location in the pre-defined SSB format/pattern.

When a UE approaches and passes an RRH, the network needs to switch the RRH that serves the UE. Meanwhile, a TCI state switch occurs. This is illustrated in FIG. 4, where a TCI state switch is demonstrated by different serving SSB indexes.

When the UE switches the RRH with which it is communication, i.e., because of a TCI state update that corresponds to a change of RRH among consecutive RRHs, its timing will initially be incorrect or out of adjustment range or discontinuous. If the UE is travelling towards RRH, then just before it passes one RRH it will be close and the propagation delay and timing adjustment almost zero. Immediately after the UE starts transmitting to the next RRH, the propagation delay will jump and the currently set UL timing will be incorrect. If the UE is travelling away from RRH then the opposite will occur; just before the UE passes a RRH it will be at its maximum distance (and hence maximum propagation delay and timing advance) from the previous RRH. When the UE first begins transmitting to the new RRH, it will be close and the propagation delay will be near zero, but the timing advance will still be a large value. The order of timing offset is shown in FIG. 5, which shows propagation delay for the serving beam in a uni-directional deployment. As seen in the figure, which represents a scenario where BSs/RRHs are located at Ds, 2Ds, 3Ds, the timing jumps when switching serving beam near the BS/RRH.

There are two kinds of one-shot UL timing adjustment options to address the issue of timing jumps in 3GPP Rel17. One option is to perform a RACH procedure. Network node commands UE to start the RACH procedure to re-acquire the cell/beam and assigns the correct TA to the UE. The other operation is called the autonomous one-shot UL timing adjustment. With this procedure, the UE autonomously adjusts its UL timing and ignores TA in TAC by network node.

### SUMMARY

In an HST scenario, the TCI state of a UE needs to be frequently updated as the train moves along the track. The updates of TCI state can be categorized to 2 types:
TCI state switch within same RRH/TRP
TCI state switch among (consecutive) RRHs/TRPs

Currently, the beam/TCI state switching procedure assumes that the same TA is applicable to the UE in source and target beam in the same cell. Therefore, with existing procedures, a UE cannot reliably distinguish between the two categories of TCI state update. This can cause delays in acquiring the correct timing when TCI state switches occur.

To alleviate unnecessary delays resulting from TCI state switches that arises within same RRH/TRP, it is desirable that the UE be able to differentiate between the two categories of TCI states discussed above, i.e., between TCI state changes involving the same BS/TRxP/RRH as source and target, and TCI state changes involving different BS/TRxP/RRH as source and target for the switch.

This document addresses these problems by providing a set of methods for a network node to extend existing configurations or using new signaling to indicate to the UE when the UE is likely to face UL transmit timing that is out of UE capability (e.g., Te, Tq or CP length), and in turn for a UE to perform corresponding UE processes or behavior adaptively, based on the signaling. The UE processes or behavior may consist of, for example, (one-shot) UL timing adjustment or TA update or state switch or beam management, for intra-cell changes, or cell changes with respect to the configuration, for inter-cell changes.

In various embodiments, the network provides an indication to the UE that is based on a network node determination with respect to whether a TCI state switch is within the same RRH/TRxP or among different RRH/TRxPs. The same or similar indication might also be used, in various embodiments, to signal other determinations by the network node with respect to other metrics that are related to UL transmit timing change.

In some embodiments of the techniques described herein, a method comprises a network node configuring signaling that indicates to the UE that a change in UL transmit timing associated with an event corresponding to the signaling is out of UE capability. One particular example is that TCI States Activation/Deactivation signaling is extended to indicate whether the TCI state ID to be activated and the TCI state ID to be deactivated are from same RRH/TRP or different RRHs/TRPs.

One particular example is that the TCI State Indication for UE-specific PDCCH MAC CE or enhanced TCI State Indication for UE-specific PDCCH MAC CE is extended to indicate whether the TCI state ID to be activated (i.e., the target TCI state) and the TCI state ID to be deactivated (i.e., the old TCI state) are from the same RRH/TRP or different RRHs/TRPs.

In some embodiments, this indication may be in separate signaling, e.g., RRC, MAC-CE or DCI command. The separate signaling shall be informed to UE at the least before UE starts a process or behavior associated with the signaling.

In various embodiments, a UE that receives this signaling executes a process or behavior based on the signaling signaled by network node. One particular example is, when a UE receives TCI state switching command, i.e., indication of TCI States Activation/Deactivation:
If the indication within indicates the target TCI state and the old TCI state are from same RRH/TRP, the UE shall in turn do TCI state switch without one-shot UL timing adjustment and complete TCI state switch, or.
If the indication indicates the target TCI state and the old TCI state are from different RRH/TRP, UE shall in turn do TCI state switch with one-shot UL timing adjustment and complete TCI state switch within T2.

It will be appreciated that the first approach can be completed in a shorter time frame, e.g., within a time T1, that is shorter than the time T2 required for the latter.

An indication such as that described above may be interpreted by the UE as, when the indication indicates the target TCI state and the old TCI state are from same RRH/TRP, the UE shall follow UL timing adjustment specified in clause 7.1.2.1 in 3GPP TS 38.133 V18.0.0, i.e., the process described therein as “Gradual timing adjustment.” When the indication instead indicates the target TCI state and the old TCI state are from different RRH/TRP, the UE shall follow UL timing adjustment specified in clause 7.1.2.3 in 3GPP TS38.133 V18.0.0, i.e., the process described therein as “One-shot large timing adjustment.” Another example response to this latter indication is that when the UE receives indication contained by TCI state switching command, then UE shall start RACH procedure before applying the TCI state or after applying the TCI state.

In various embodiments, if the UE receives the indication by separate signaling, e.g., RRC, MAC-CE or DCI command before executing an associated process or behavior, then the UE shall adapt process or behavior to be executed based on the indication. Otherwise, UE shall use the latest received indication or default indication for the process or behavior to be executed.

Thus, in various embodiments a network node indicates to the UE whether a TCI state (or beam or cell) to be switched is from same or different RRH/TRP compared to the old TCI state, or within or outside the UE's capability to deal with UL transmit timing, or requesting TA update or not in some scenario, e.g., multi-RRH/TRP in one cell. This approach can also be applied to cell change, where the indication indicates the cell to be changed is within or outside UE capability to deal with UL transmit timing, i.e., requesting TA update or not. In this way, the UE can perform more efficient TA update procedures and avoid unnecessary RACH procedures. The delays due to unnecessary RACH procedures are reduced.

An example method according to some of these embodiments is carried out by a UE and is for adjusting timing with respect to a serving cell in a wireless network. This example method comprises receiving from the wireless network, in or associated with a message or command changing an active configuration of the UE, an indication of whether the change in active configuration of the UE corresponds to one or both of (i) a change in Remote Radio Head, RRH, or transmission point(s), TRP(s), for transmissions from the wireless network to the UE and (ii) a change in uplink, UL, transmit timing and/or timing advance, TA, for the UE that exceeds the UE's capability to track with gradual timing adjustment procedures specified for the UE. The example method further comprises performing one or more timing-adjustment operations, based on the indication.

Another example method is carried out by a network node and is for assisting a UE to adjust timing with respect to a serving cell in a wireless network. This example method comprises determining whether a message or command to be sent to the UE to change an active configuration of the UE corresponds to one or both of (i) a change in Remote Radio Head, RRH, or transmission point(s), TRP(s), for transmissions from the wireless network to the UE and (ii) a change in uplink, UL, transmit timing and/or timing advance, TA, for the UE that exceeds the UE's capability to track with gradual timing adjustment procedures specified for the UE. The method further comprises sending an indication to the UE in or in association with the message or command, based on said determining.

Variations of these methods are described in detail below, as are corresponding apparatuses and systems in which these and related techniques may be implemented.

### BRIEF DESCRIPTION OF THE DRAWINGS

FIG. 1 illustrates an example HST deployment scenario.

FIG. 2 shows uni-directional deployment in an HST scenario, and corresponding beam operation.

FIG. 3 shows bi-directional deployment in an HST scenario, and corresponding beam operation.

FIG. 4 illustrates an example of TCI state switch in an HST scenario, and the corresponding immediate change of the timing advance (TA).

FIG. 5 illustrates propagation delays for serving beams in a uni-directional HST deployment.

FIG. 6 illustrates details of a TCI State indication MAC CE.

FIG. 7 shows details of a PUCCH Spatial Relation Activation/Deactivation MAC CE.

FIG. 8 is a process flow diagram illustrating an example method as carried out by a UE, in some embodiments.

FIG. 9 is a process flow diagram illustrating an example method carried out by a network node, according to some embodiments.

FIG. 10 shows an example communication system, according to some embodiments.

FIG. 11 illustrates components of an example UE, according to some embodiments.

FIG. 12 illustrates components of an example network node, according to some embodiments.

FIG. 13 shows an example host, while FIG. 14 illustrates an example virtualization environment.

FIG. 15 shows a communication diagram of a host communicating via a network node with a UE over a partially wireless connection.

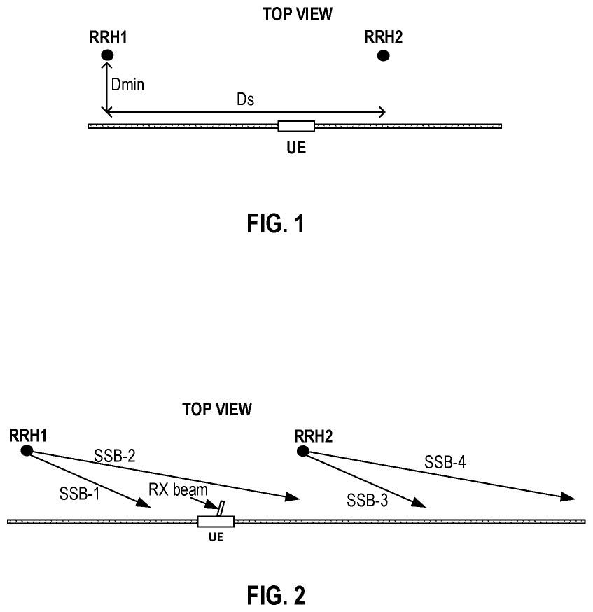

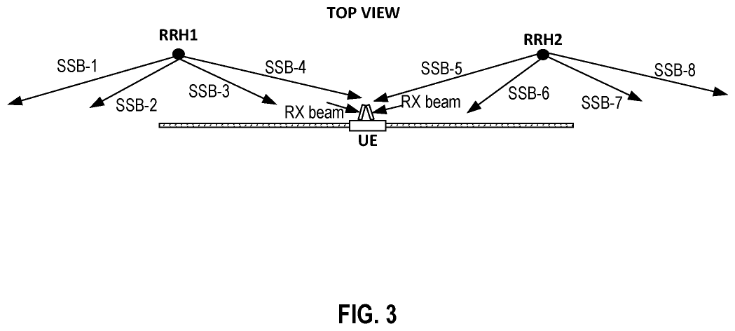

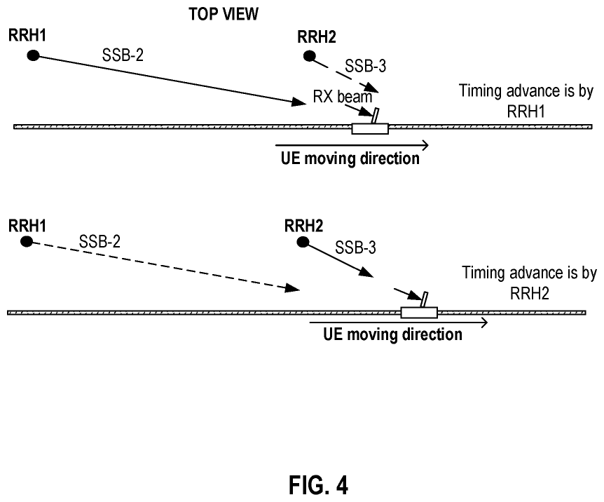

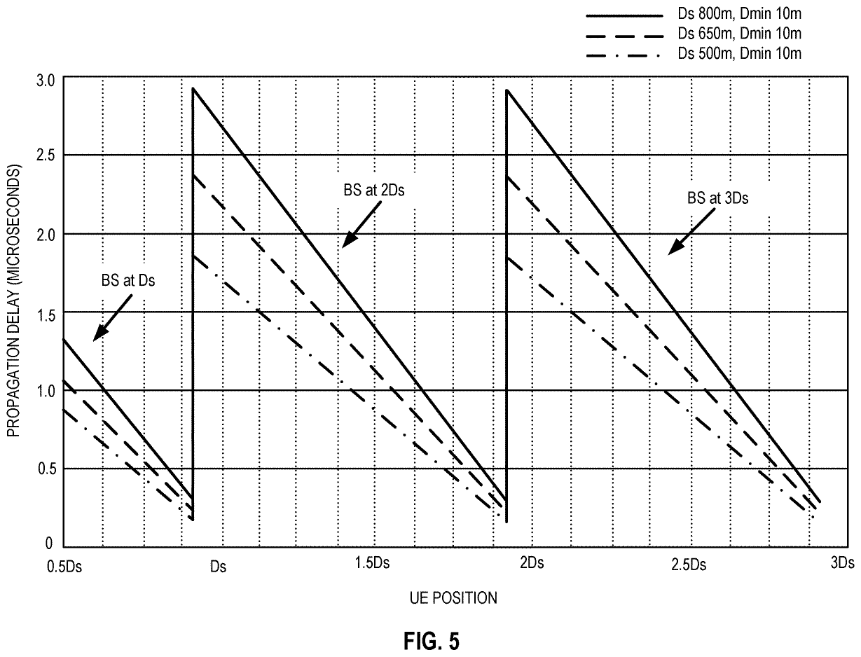

### DETAILED DESCRIPTION

Some of the embodiments contemplated herein will now be described more fully with reference to the accompanying drawings. Embodiments are provided by way of example to convey the scope of the subject matter to those skilled in the art.

As noted above, in an HST scenario, the TCI state of a UE needs to be frequently updated as the train moves along the track. The updates of TCI state can be categorized to 2 types:
TCI state switch within same RRH/TRP
TCI state switch among (consecutive) RRHs/TRPs

Currently, the beam/TCI state switching procedure assumes that the same TA is applicable to the UE in source and target beam in the same cell. Therefore, with existing procedures, a UE cannot distinguish between the two categories of TCI state update.

In some UE implementations, a UE may be able to assess and determine the timing variations (e.g., based on reception on DL signal from different RRHs) when the UE changes between the source RRH and the target RRH and subsequently estimate the category of the TCI state update. Nevertheless, the estimation may be inaccurate, e.g., due to timing errors occurred at the UE.

Given that, UE may perform one-shot UL timing adjustment even when TCI state switch arises within the same RRH/TRP and consequently the TCI state switch delay is prolonged by ‘Tᵣₛ+T_{rs-proc},’ when the UE follows the below requirements defined in 3GPP TS 38.133 V18.0.0:

### 8.10.3A MAC-CE Based TCI State Switch Delay in HST FR2 Scenarios

For FR2 power class 6 UE, if the target TCI state is known, upon receiving PDSCH carrying MAC-CE activation command in slot n, UE shall be able to receive PDCCH with target TCI state of the serving cell on which TCI state switch occurs at the symbol m of the first slot that is after slot

$$n + {T}_{HARQ} + 3 {N}_{slot}^{subframe , μ} + {TO}_{k} * \{ {T}_{first - SSB} + {T}_{SSB - proc} + {T}_{rs} + {T}_{rs - proc} ) \text{} / NR slot length .$$

The UE shall be able to receive PDCCH with the old TCI state until slot

$$n + {T}_{HARQ} + 3 {N}_{slot}^{subframe , μ} .$$

Where T_{HARQ} the timing between DL data transmission and acknowledgement as specified in TS 38.213 [3];
T_{first-SSB} is time to first SSB transmission after MAC CE command is decoded by the UE;
T_{SSB-proc}=2 ms;
Tᵣₛ is time to the first TRS or SSB transmission after the SSB transmission in the definition of T_{first-SSB} is processed by the UE;
T_{rs-proc}=2 ms;
TOₖ=1, m=0 if target TCI state is not in the active TCI state list for PDSCH; otherwise TOₖ=0, m=1.

For FR2 power class 6 UE, if the target TCI state is unknown, the same requirement for unknown target TCI state case specified in clause 8.10.3 applies.

To alleviate unnecessary delays resulting from TCI state switches that arises within same RRH/TRP, it is desirable that the UE be able to differentiate between the two categories of TCI states discussed above, i.e., between TCI state changes involving the same BS/TRxP/RRH as source and target, and TCI state changes involving different BS/TRxP/RRH as source and target for the switch.

In an example, but non-limiting, scenario, a UE is served by at least a first cell (Cell1) which is managed or served by a first network node (NW1) (e.g., an NR base station). The UE may support at least a certain power class capability e.g., FR2 power class 6 (PC6). NW1 may be a separate node (e.g., logical or physical node) or one of the transmission receptions points (TRP) belonging to a set of TRPs belonging to the same cell. The term RRH may be used to refer to either of these nodes. Cell1 may be served by one or more TRPs e.g., up to M number of TRPs. This implies or means that the UE can operate with signals in Cell1 using up to M number of TRPs. In one example, M equals to 2 in one cell and in another example, M equals to 4 in another cell.

The UE may also be served by more than one cell (e.g., Cell1 as well as a second cell, Cell2, etc.) in multicarrier operation such as in carrier aggregation (CA), multi-connectivity, dual connectivity (DC), etc. Examples of serving cells thus include a special cell (SpCell), a secondary cell (SCell), etc. Cell2 may also be served by one or more TRPs e.g., up to N number of TRPs. This implies or means that the UE can operate transmissions or receptions in Cell2 using up to N number of TRPs. In some embodiments, N<M or N=M. In one example, N=1 and in another example N=2. Examples of a SPCell are PCell, PSCell etc. In an example, Cell1 and Cell2 may operate on a first carrier frequency (F1) and on a second carrier frequency (F2) respectively. The term TRP may also be called as remote radio head (RRH). While these terms may refer to different types of nodes, these terms are inter-changeably applicable to the techniques described herein, without losing their meaning.

Note that while the background and scenarios described herein are primarily based on the HST scenario, which provides a particular motivation for the solutions described herein, the issues and the solutions proposed to address the issues also are applicable in other multi-TRP scenarios. The solutions can also be applied to cell change, e.g., handover, RACH-less handover, etc.

In various ones of the embodiments described herein, the gNB may send a TCI state switch command to a UE indicating that the UE shall switch from current TCI states (referred to as old TCI states) to the target TCI states indicated in the TCI state switch command. The TCI state switch command is used for controlling TCI states for reception (e.g., PDCCH, PDSCH) or transmission (e.g., SRS, PUCCH, PUSCH) for the UE.

A TCI state switch command may be carried by a RRC signaling, a MAC CE or a DCI, in various instances. A TCI state switch command may indicate one or multiple target TCI states. When the UE receives a TCI state switch command, the UE may have the same number of old TCI states as the target TCI states.

Upon reception of a TCI state switch command, the UE switches each old TCI state to its target TCI state. A target TCI state is also referred to as a TCI state to be activated. An old TCI state is also referred to as a TCI state to be deactivated.

In some embodiments of the techniques described herein, TCI state switch signaling is extended to include indicators indicating whether each target TCI state belongs to the same or different RRH compared to its old TCI state.

In some of these embodiments, a TCI state switch command is carried via a RRC signaling. in this case, the indicators are included in the RRC signaling.

In an example, the indicators may be defined as Boolean fields. For example, each field is set to “True” to indicate the corresponding target TCI state belongs to a different RRH from the old TCI state. Each field is set to “False” to indicate the corresponding target TCI state belongs to the same RRH as the old TCI state. Alternatively, each field is set to “True” to indicate the corresponding target TCI state belongs to the same RRH as the old TCI state, and each field is set to “False” to indicate the corresponding target TCI state belongs to a different RRH from the old TCI state.

In another example, the indicators may be defined as Binary fields. Each field is set to “1” indicating the corresponding target TCI state belongs to a different RRH from the old TCI state. Each field is set to “0” indicating the corresponding target TCI state belongs to the same RRH as the old TCI state. Alternatively, each field may be set to “1” to indicate the corresponding target TCI state belongs to the same RRH as the old TCI state, while each field is set to “0” to indicate the corresponding target TCI state belongs to a different RRH from the old TCI state.

In still another example, the indicators may be defined as Enumerated fields. For instance, each field may be set to “sameRRH” to indicate the corresponding target TCI state belongs to the same RRH as the old TCI state or set to “crossRRH” to indicate the corresponding target TCI state belongs to a different RRH from the old TCI state.

In some embodiments, a TCI state switch command is carried via a MAC CE. in this case, the indicators are included in the MAC CE. In one example approach, the indicators are included in a MAC subheader, where the indicators are defined as new fields or assigned to reserved fields. Alternatively, some existing fields may be repurposed to carry the indicators. In another approach, the indicators are included in a MAC CE payload (e.g., “TCI State Indication for UE-specific PDCCH MAC CE” or “Enhanced TCI States Indication for UE-specific PDCCH MAC CE” for controlling TCI states for PDCCH reception). Again, the indicators may be defined as new fields or occupy reserved fields. Alternatively, some existing fields may be repurposed to carry the indicators.

In some embodiments or instances, a TCI state switch command may be carried via a DCI. in this case, the indicators may be included in the DCI. Once again, the indicators may be defined as new fields, or occupy reserved fields. Alternatively, some existing fields may be repurposed to carry the indicators.

In some examples of any of the above embodiments, the indicators may be defined as a bitmap field comprising multiple bits where each bit corresponds to a target TCI state. In an example, each field is set to the value “1” to indicate the corresponding target TCI state belongs to a different RRH from the old TCI state, while each bit is set to the value “0” to indicate that the corresponding target TCI state belongs to the same RRH as the old TCI state. Alternatively, in another example each field is set to the value “1” to indicate the corresponding target TCI state belongs to the same RRH as the old TCI state and each bit is set to the value “0” to indicate that the corresponding target TCI state belongs to a different RRH from the old TCI state.

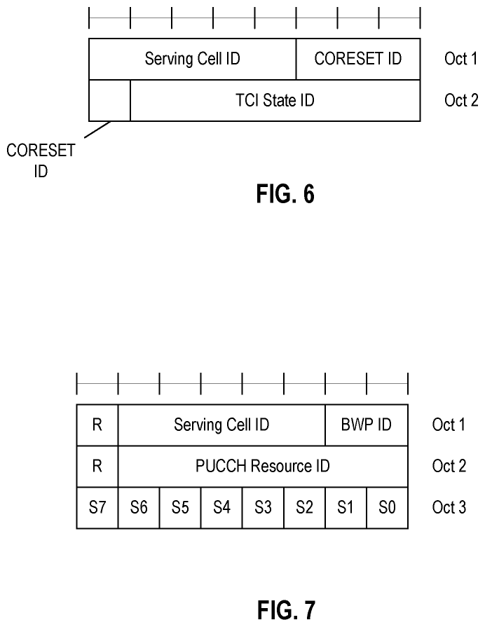

In some embodiments, the TCI State Indication for UE-specific PDCCH MAC CE may be identified by a MAC subheader with LCID. This is illustrated in FIG. 6, which shows that it has a fixed size of 16 bits with the following fields:
Serving Cell ID;
CORESET ID; and
TCI State ID.

To add the indication discussed above, an extra field called ‘Cross_TRP,’ occupying 1 bit, can be added on the existing 16 bits. In one example, the field ‘Cross_TRP’ is set to the value “1” to indicate the target TCI state ID is from a different RRH/TRP, compared to the old TCI state. In another example, the field ‘Cross_TRP’ is set to the value “1” to indicate that the target TCI state ID corresponds to the same RRH/TRP as the old TCI state.

In one example, if the field ‘Cross_TRP’ indicates that the target TCI state ID is from a different RRH/TRP, compared to the old TCI state, and the UE has no capability to perform autonomous one-shot UL timing adjustment, the UE may perform RACH procedure after receiving the TCI state switch command to re-acquire a correct TA to the UE. Alternatively, after sending the TCI switch command containing ‘Cross_TRP’=1, the gNB may send another signaling to trigger the UE to perform RACH procedure to re-acquire a correct TA.

In another example, if the field ‘Cross_TRP’ indicates that the target TCI state ID is from a different RRH/TRP, compared to the old TCI state, and the UE has capability to perform autonomous one-shot UL timing adjustment, the UE may perform TCI state switch procedure and assume TOₖ=1 (see details in Clause 2.3) if target TCI state is not in the active TCI state list for PDSCH; otherwise TOₖ=0.

In some examples, if the field ‘Cross_TRP’ is set to indicate that the target TCI state ID corresponds to the same RRH/TRP as the old TCI state, the UE shall perform TCI state switch procedure and assume TOₖ=0, where TOₖ is applied as specified in Section 8.10.3A of 3GPP TS 38.133, v18.0.0 (see excerpt provided above).

In other examples, if the field ‘Cross_TRP’ is set to indicate that the target TCI state ID corresponds to the same RRH/TRP as the old TCI state, UE shall follow the UL timing adjustment specified in clause 7.1.2.1 in 3GPP TS 38.133 V18.0.0, i.e., the process described therein as “gradual timing adjustment.” Conversely, if the field ‘Cross_TRP’ indicates that the target TCI state ID is from a different RRH/TRP, compared to the old TCI state, then the same UE may instead follow the UL timing adjustment specified in clause 7.1.2.3 in 3GPP TS 38.133 V18.0.0, i.e., the process described therein as “One-shot large timing adjustment.”

A TCI state switch relating to a change in TRPs/RRHs may cause the difference of UL transmit timing between the target TCI state and the old TCI state to remain within UE's UL transmit timing capability or out of UE's UL transmit timing capability, in various circumstances. Consequently, rather than the indication discussed above expressly indicating whether or not a TCI state switch or other configuration change involves a change in TRP/RRH, the indication might instead reflect any need/request/demand for UL transmit timing adjustment explicitly or implicitly, with the indication indicating whether, for example, coarse or fine. One example of this approach is for the network node to the field ‘Cross_TRP’ to be the value “1” to indicate that the UL transmit timing before/after TCI state switch is out of legacy requirements, e.g., to indicate that clause 7.1.2.1 in 3GPP TS 38.133 V18.0.0 applies; otherwise the network node sets the field ‘Cross_TRP’ to be the value “0” to indicate that UL transmit timing before/after TCI state switch is within legacy requirements, e.g., clause 7.1.2.1 in 3GPP TS 38.133 V18.0.0. In some embodiments, this may be done without regard to whether the TCI state switch involves a change in TRP/RRH, such that the latter indication (that UL transmit timing adjustments remain within legacy requirements) may apply even if the TRP/RRH is changed.

For sake of simplicity and various specific use cases, some examples use the concept of ‘Cross_TRP’ and some examples use the concept of ‘update_TA’, or ‘update_UL_timing.’ In one example the field ‘update_TA’ is set to 1 to indicate TCI state ID to be activated and the TCI state ID to be deactivated are out of UE's UL transmit timing capability. In another example the field ‘update_TA’ is set to 0 to indicate TCI state ID to be activated and the TCI state ID to be deactivated are within UE's UL transmit timing capability.

The general approach described above is also applicable to Spatial Relation Activation/Deactivation, through extending the indication of Spatial Relation Activation/Deactivation to contain an indication indicating whether PUCCH Resource ID to be activated and the PUCCH Resource ID to be deactivated are from same RRH/TRP or different RRHs/TRPs, and/or indicating whether this change in PUCCH Resource ID is associated with a change in UL timing that falls within or outside the legacy requirements, i.e., such that gradual timing adjustments are adequate or more drastic adjustments, such as with the one-shot adjustment procedure, are needed.

In some such embodiments, the PUCCH spatial relation Activation/Deactivation MAC CE is identified by a MAC subheader with LCID. As shown in FIG. 7, this subheader has a fixed size of 24 bits with following fields:
Serving Cell ID
BWP ID
PUCCH Resource ID
Sᵢ
R.

To add the indication described above, an extra field called ‘Cross_TRP_PUCCH’ (or something similar) occupying at least one can be added in reserved bits. In one example, this field may be set to 1 to indicate PUCCH ID to be activated and the PUCCH ID to be deactivated are from different RRHs/TRPs or to 0 to indicate the PUCCH ID to be activated and the PUCCH ID to be deactivated are from the same RRH/TRP, or vice versa.

In other embodiments or instances, the aforementioned indication may be in a separate signaling, e.g., RRC, MAC-CE or DCI command. The separate signaling shall be informed to UE at the latest before the UE starts a process or behavior with respect to the signaling. This process or behavior may comprise, for example:
UL timing adjustment, or
TA update, or
state switch or beam management, or
cell change.

After UE receives the indication by separate signaling before executing process or behavior, then UE shall adapt process or behavior to be executed based on the indication. Otherwise, the UE shall use the latest received indication or default indication for process or behavior to be executed.

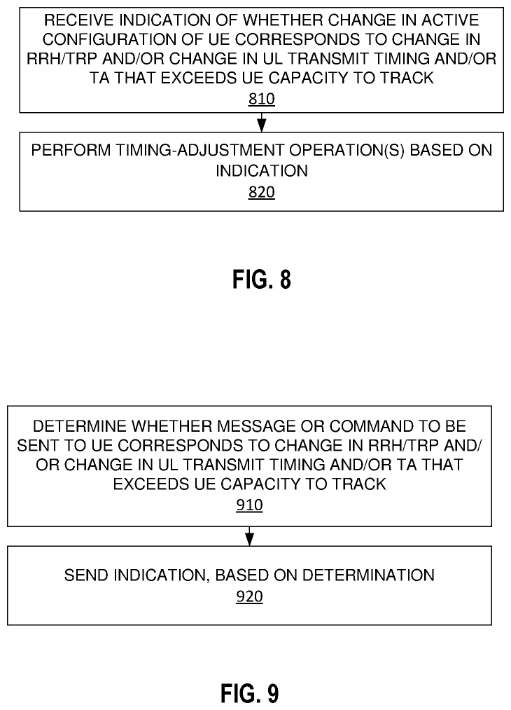

In view of the detailed examples and explanations provided above, it will be appreciated that FIG. 8 is a process flow diagram that illustrates a generalized method, as carried out by a UE, for adjusting timing with respect to a serving cell in a wireless network. This method, as illustrated in FIG. 8 and described in further detail below, is intended to be a generalization of the various techniques described above, from the perspective of a UE, such as an HST UE. Thus, where the terminology used in FIG. 8 and the description below differs from similar or clearly related terminology used above, the terminology in FIG. 8 and below should be understood as at least encompassing the terminology used to describe specific examples above.

As shown at block 810, the method includes the step of receiving from the wireless network, in or associated with a message or command changing an active configuration of the UE, an indication of whether the change in active configuration of the UE corresponds to one or both of (i) a change in RRH or TRP(s) for transmissions from the wireless network to the UE and (ii) a change in UL transmit timing and/or TA for the UE that exceeds the UE's capability to track with gradual timing adjustment procedures specified for the UE. As shown at block 820, the method further comprises performing one or more timing-adjustment operations, based on the indication.

Consistently with several of the specific examples provided above, the message or command referred to here may be a message or command changing a TCI state for the UE.

In some embodiments or instances, the indication referred to here may be included in an RRC message changing the TCI state for the UE, where the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE. In other embodiments or instances, the indication may be included in a MAC CE changing the TCI state for the UE, where the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE. In still other embodiments or instances, the indication may be included in DCI changing the TCI state for the UE, where the indication again indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

In several embodiments or instances, the one or more timing-adjustment operations may comprise performing an autonomous one-shot UL timing adjustment or a RA procedure in response to the indication indicating that the target TCI state belongs to a different RRH or TRP(s) from the RRH or TRP(s) for the previous TCI state and/or indicating that a change in UL transmit timing and/or TA associated with the target TCI state exceeds the UE's capability to track with gradual timing adjustment procedures specified for the UE. In other embodiments or instances, the one or more timing-adjustment operations comprises performing gradual timing adjustment procedures specified for the UE in response to the indication indicating that the target TCI state belongs to the same RRH or TRP(s) as the RRH or TRP(s) for the previous TCI state and/or indicating that a change in UL transmit timing and/or TA associated with the target TCI state is within the UE's capability to track with gradual timing adjustment procedures specified for the UE.

In other embodiments or instances, the message or command is a message or command changing a spatial relation for the UE. In some of these embodiments or instances, the indication may be included in a MAC CE changing the spatial relation for the UE, where the indication indicates whether a PUCCH Resource ID to be activated by the message or command belongs to a different RRH or TRP(s) from the RRH or TRP(s) for a previous TCI state and/or indicates whether a change in UL transmit timing and/or TA associated with the change in spatial relation for the UE exceeds the UE's capability to track with gradual timing adjustment procedures specified for the UE.

As was the case with several embodiments or instances related to TCI state switch, in some embodiments or instances related to the change in spatial relation, the one or more timing-adjustment operations may comprise performing an autonomous one-shot UL timing adjustment or a RA procedure in response to the indication indicating that the PUCCH Resource ID to be activated by the message or command belongs to a different RRH or TRP(s) from the RRH or TRP(s) for a previous TCI state and/or indicates that a change in UL transmit timing and/or TA associated with the change in spatial relation for the UE exceeds the UE's capability to track with gradual timing adjustment procedures specified for the UE. In other embodiments or instances, the one or more timing-adjustment operations may comprise performing gradual timing adjustment procedures specified for the UE in response to the indication indicating that the PUCCH Resource ID to be activated by the message or command belongs to the same RRH or TRP(s) as the RRH or TRP(s) for a previous TCI state and/or indicates that a change in UL transmit timing and/or TA associated with the change in spatial relation for the UE is within the UE's capability to track with gradual timing adjustment procedures specified for the UE.

FIG. 9 is a process flow diagram that illustrates a generalized method, as carried out by a network node, for facilitating the adjusting, by a UE, of timing with respect to a serving cell in a wireless network. This method complements that shown in FIG. 8, and may be carried out by, for example, a gNB, or other base station or base station element. Again, this method, as illustrated in FIG. 9 and described in further detail below, is intended to be a generalization of the various techniques described above, but from the perspective of a network node, such as a gNB in an HST deployment. Thus, where the terminology used in FIG. 9 and the description below differs from similar or clearly related terminology used above, the terminology in FIG. 9 and below should be understood as at least encompassing the terminology used to describe specific examples above.

The method begins, as shown at block 910, with determining whether a message or command to be sent to the UE to change an active configuration of the UE corresponds to one or both of (i) a change in Remote Radio Head, RRH, or transmission point(s), TRP(s), for transmissions from the wireless network to the UE and (ii) a change in UL transmit timing and/or TA for the UE that exceeds the UE's capability to track with gradual timing adjustment procedures specified for the UE. The method further comprises, as shown at block 920, with sending an indication to the UE in or in association with the message or command, based on said determining.

In some embodiments or instances, the message or command is a message or command changing a TCI state for the UE. It will be appreciated that the determination of whether this change in TCI state corresponds to a change in RRH or TRP for the UE is straightforward, as the network node indicating this TCI state switch knows to which RRH or TRP the state switch relates. Determining whether the state switch corresponds to a change in UL transmit timing and/or TA for the UE may require additional knowledge of the deployment geometry and/or the current TA/UL transmit timing for the UE.

In some of these embodiments or instances, sending the indication may comprise including the indication in an RRC message changing the TCI state for the UE, where the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE. In other embodiments or instances, sending the indication may comprise including the indication in a MAC CE changing the TCI state for the UE, where the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE. Likewise, in still other embodiments or instances, sending the indication may comprise including the indication in DCI changing the TCI state for the UE, where, once more, the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

In other embodiments or instances, the message or command may be a message or command changing a spatial relation for the UE. In these embodiments or instances, the determining may involve the use of information relating to the system geometry and/or the UE's current spatial relation and/or TA/UL transmit timing.

In some of these embodiments or instances, sending the indication may comprise including the indication in a MAC CE changing the spatial relation for the UE, where the indication indicates whether a PUCCH Resource ID to be activated by the message or command belongs to a different RRH or TRP(s) from the RRH or TRP(s) for a previous TCI state and/or indicates whether a change in UL transmit timing and/or TA associated with the change in spatial relation for the UE exceeds the UE's capability to track with gradual timing adjustment procedures specified for the UE.

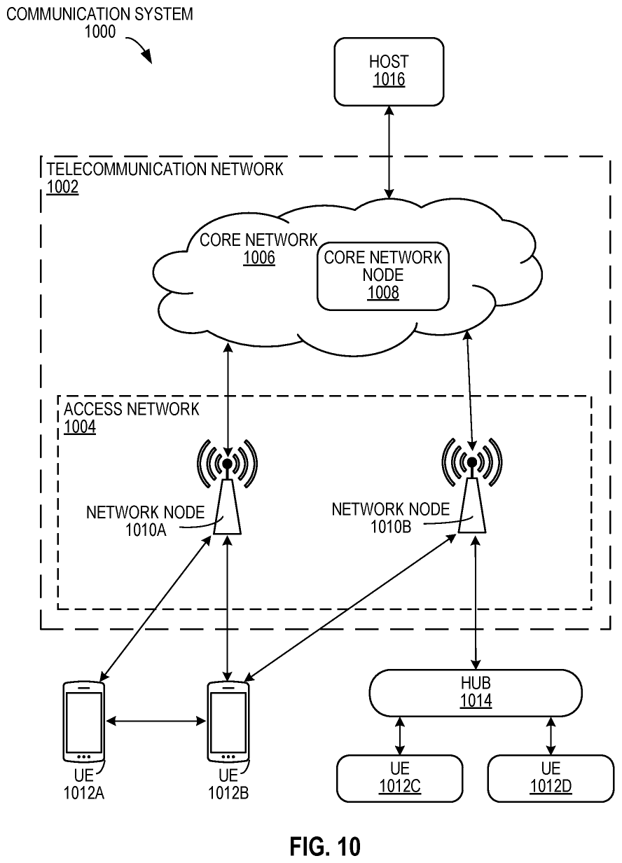

FIG. 10 shows an example of a communication system 1000 in accordance with some embodiments. This example system provides a general context for the techniques described above. Some of the described details or variants may not be applicable to an HST deployment or other network deployment in which the techniques described are implemented.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1002 includes one or more Open-RAN (ORAN) network nodes. An ORAN network node is a node in the telecommunication network 1002 that supports an ORAN specification (e.g., a specification published by the O-RAN Alliance, or any similar organization) and may operate alone or together with other nodes to implement one or more functionalities of any node in the telecommunication network 1002, including one or more network nodes 1010 and/or core network nodes 1008.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

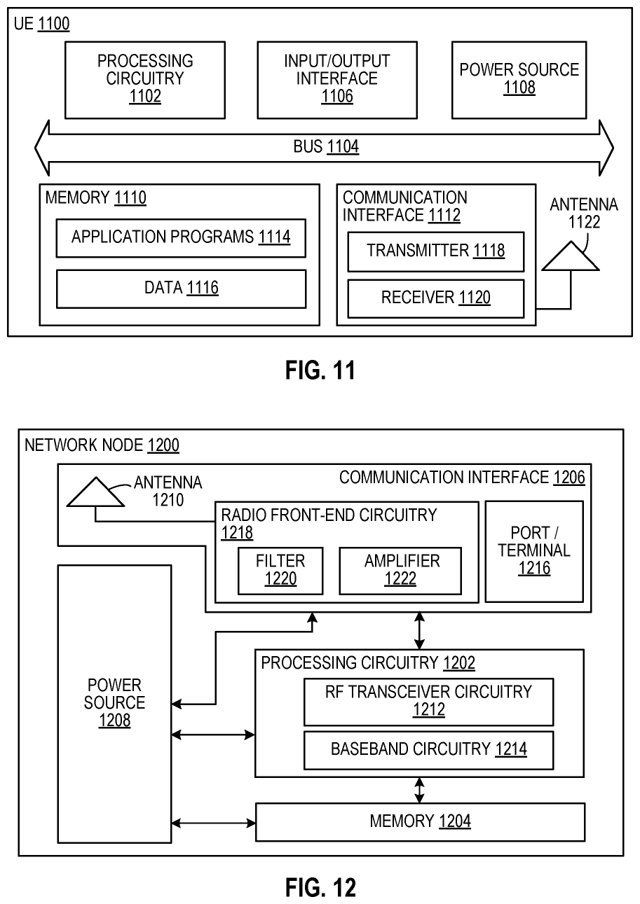

FIG. 11 shows a UE 1100 in accordance with some embodiments. Several of the methods described above may be implemented in some of these embodiments. However, some of the details or variants described here may not be applicable to, for example, an HST UE. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. Several of the techniques described herein in relation to network nodes, base stations, or the like may be implemented in a network node 1200 having some or all of these features. However, some of the details or variants may be inapplicable or unnecessary to, for example, a gNB in an HST deployment utilizing the techniques described herein.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

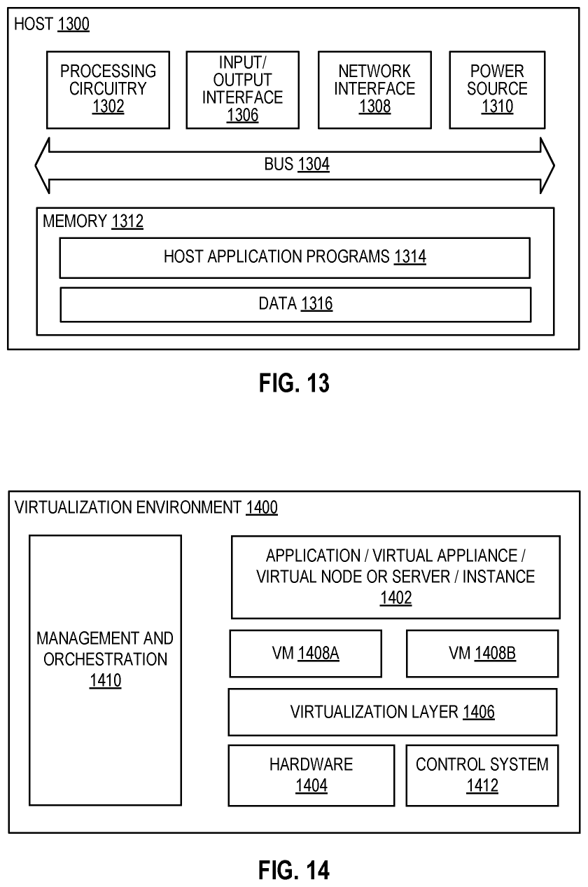

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1400 includes components defined by the O-RAN Alliance, such as an O-Cloud environment orchestrated by a Service Management and Orchestration Framework via an O-2 interface.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

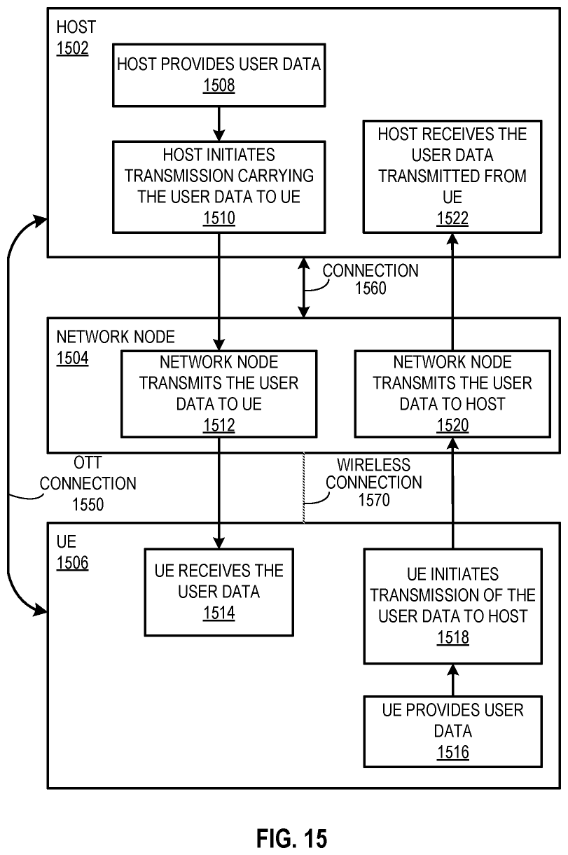

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve the UE's ability to track TA and UL timing, and thereby provide benefits such as reducing latencies and/or service interruptions resulting from unnecessary re-acquisitions of UL tracking times in, for example, HST scenarios.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Embodiments of the techniques, apparatuses, and systems described herein include, but are not limited to, the following enumerated examples:

1. A method, in a user equipment, UE, for adjusting timing with respect to a serving cell in a wireless network, the method comprising:
receiving from the wireless network, in or associated with a message or command changing an active configuration of the UE, an indication of whether the change in active configuration of the UE corresponds to one or both of (i) a change in Remote Radio Head, RRH, or transmission point(s), TRP(s), for transmissions from the wireless network to the UE and (ii) a change in uplink, UL, transmit timing and/or timing advance, TA, for the UE that exceeds the UE's capability to track with gradual timing adjustment procedures specified for the UE; and
performing one or more timing-adjustment operations, based on the indication.

2. The method of example embodiment 1, wherein the message or command is a message or command changing a Transmission Configuration Indication, TCI, state for the UE.

3. The method of example embodiment 2, wherein the indication is included in an RRC message changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

4. The method of example embodiment 2, wherein the indication is included in an Medium Access Control, MAC, Control Element, CE, changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

5. The method of example embodiment 2, wherein the indication is included in Downlink Control Information, DCI, changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

6. The method of any of example embodiments 2-5, wherein the one or more timing-adjustment operations comprises performing an autonomous one-shot UL timing adjustment or a random access, RA, procedure in response to the indication indicating that the target TCI state belongs to a different RRH or TRP(s) from the RRH or TRP(s) for the previous TCI state and/or indicating that a change in UL transmit timing and/or TA associated with the target TCI state exceeds the UE's capability to track with gradual timing adjustment procedures specified for the UE.

8. The method of any of example embodiments 2-5, wherein the one or more timing-adjustment operations comprises performing gradual timing adjustment procedures specified for the UE in response to the indication indicating that the target TCI state belongs to the same RRH or TRP(s) as the RRH or TRP(s) for the previous TCI state and/or indicating that a change in UL transmit timing and/or TA associated with the target TCI state is within the UE's capability to track with gradual timing adjustment procedures specified for the UE.

9. The method of example embodiment 1, wherein the message or command is a message or command changing a spatial relation for the UE.

10. The method of example embodiment 9, wherein the indication is included in an Medium Access Control, MAC, Control Element, CE, changing the spatial relation for the UE, and wherein the indication indicates whether a Physical Uplink Control Channel, PUCCH Resource ID to be activated by the message or command belongs to a different RRH or TRP(s) from the RRH or TRP(s) for a previous TCI state and/or indicates whether a change in UL transmit timing and/or TA associated with the change in spatial relation for the UE exceeds the UE's capability to track with gradual timing adjustment procedures specified for the UE.

11. The method of example embodiment 10, wherein the one or more timing-adjustment operations comprises performing an autonomous one-shot UL timing adjustment or a random access, RA, procedure in response to the indication indicating that the PUCCH Resource ID to be activated by the message or command belongs to a different RRH or TRP(s) from the RRH or TRP(s) for a previous TCI state and/or indicates that a change in UL transmit timing and/or TA associated with the change in spatial relation for the UE exceeds the UE's capability to track with gradual timing adjustment procedures specified for the UE.

12. The method of example embodiment 10, wherein the one or more timing-adjustment operations comprises performing gradual timing adjustment procedures specified for the UE in response to the indication indicating that the PUCCH Resource ID to be activated by the message or command belongs to the same RRH or TRP(s) as the RRH or TRP(s) for a previous TCI state and/or indicates that a change in UL transmit timing and/or TA associated with the change in spatial relation for the UE is within the UE's capability to track with gradual timing adjustment procedures specified for the UE.

13. A method, in a network node, for assisting a user equipment, UE, to adjust timing with respect to a serving cell in a wireless network, the method comprising:
determining whether a message or command to be sent to the UE to change an active configuration of the UE corresponds to one or both of (i) a change in Remote Radio Head, RRH, or transmission point(s), TRP(s), for transmissions from the wireless network to the UE and (ii) a change in uplink, UL, transmit timing and/or timing advance, TA, for the UE that exceeds the UE's capability to track with gradual timing adjustment procedures specified for the UE; and,
sending an indication to the UE in or in association with the message or command, based on said determining.

14. The method of example embodiment 13, wherein the message or command is a message or command changing a Transmission Configuration Indication, TCI, state for the UE.

15. The method of example embodiment 14, wherein sending the indication comprises including the indication in an RRC message changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

16. The method of example embodiment 14, wherein sending the indication comprises including the indication in an Medium Access Control, MAC, Control Element, CE, changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

17. The method of example embodiment 14, wherein sending the indication comprises including the indication in Downlink Control Information, DCI, changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

18. The method of example embodiment 13, wherein the message or command is a message or command changing a spatial relation for the UE.

19. The method of example embodiment 18, wherein sending the indication comprises including the indication in an Medium Access Control, MAC, Control Element, CE, changing the spatial relation for the UE, and wherein the indication indicates whether a Physical Uplink Control Channel, PUCCH Resource ID to be activated by the message or command belongs to a different RRH or TRP(s) from the RRH or TRP(s) for a previous TCI state and/or indicates whether a change in UL transmit timing and/or TA associated with the change in spatial relation for the UE exceeds the UE's capability to track with gradual timing adjustment procedures specified for the UE.

20. A user equipment for adjusting timing with respect to a serving cell in a wireless network, comprising:
processing circuitry configured to perform any of example embodiments 1-12; and
power supply circuitry configured to supply power to the processing circuitry.

21. A network node for assisting a user equipment, UE, to adjust timing with respect to a serving cell in a wireless network, the network node comprising:
processing circuitry configured to perform any of example embodiments 13-19;
power supply circuitry configured to supply power to the processing circuitry.

22. A user equipment (UE) for adjusting timing with respect to a serving cell in a wireless network, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of example embodiments 1-12;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

23. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of example embodiments 13-19 to transmit the user data from the host to the UE.

24. The host of the previous embodiment, wherein:
the processing circuitry of the host is configured to execute a host application that provides the user data; and
the UE comprises processing circuitry configured to execute a client application associated with the host application to receive the transmission of user data from the host.

25. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of example embodiments 13-19 to transmit the user data from the host to the UE.

26. The method of the previous embodiment, further comprising, at the network node, transmitting the user data provided by the host for the UE.

27. The method of any of the previous 2 embodiments, wherein the user data is provided at the host by executing a host application that interacts with a client application executing on the UE, the client application being associated with the host application.

28. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of example embodiments 13-19 to transmit the user data from the host to the UE.

29. The communication system of the previous embodiment, further comprising:
the network node; and/or
the UE.

30. A host configured to operate in a communication system to provide an over-the-top (OTT) service, the host comprising:
processing circuitry configured to initiate receipt of user data; and
a network interface configured to receive the user data from a network node in a cellular network,
the network node having a communication interface and processing circuitry, the processing circuitry of the network node configured to perform any of example embodiments 13-19 to receive the user data from a user equipment (UE) for the host.

31. The host of the previous embodiment, wherein:
the processing circuitry of the host is configured to execute a host application that receives the user data; and
the host application is configured to interact with a client application executing on the UE, the client application being associated with the host application.

32. The host of any of the previous 2 embodiments, wherein the initiating receipt of the user data comprises requesting the user data.

33. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of example embodiments 13-19 to receive the user data from the UE for the host.

34. The method of the previous embodiment, further comprising at the network node, transmitting the received user data to the host.

35. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of example embodiments 1-12 to receive the user data from the host.

36. The host of the previous embodiment, wherein the cellular network further includes a network node configured to communicate with the UE to transmit the user data to the UE from the host.

37. The host of either of the previous 2 embodiments, wherein:
the processing circuitry of the host is configured to execute a host application, thereby providing the user data; and
the host application is configured to interact with a client application executing on the UE, the client application being associated with the host application.

38. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of example embodiments 1-12 to receive the user data from the host.

39. The method of the previous embodiment, further comprising:
at the host, executing a host application associated with a client application executing on the UE to receive the user data from the host application.

40. The method of the previous embodiment, further comprising:
at the host, transmitting input data to the client application executing on the UE, the input data being provided by executing the host application,
wherein the user data is provided by the client application in response to the input data from the host application.

41. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of example embodiments 1-12 to transmit the user data to the host.

42. The host of the previous embodiment, wherein the cellular network further includes a network node configured to communicate with the UE to transmit the user data from the UE to the host.

43. The host of the previous 2 embodiments, wherein:
the processing circuitry of the host is configured to execute a host application, thereby providing the user data; and
the host application is configured to interact with a client application executing on the UE, the client application being associated with the host application.

44. A method implemented by a host configured to operate in a communication system that further includes a network node and a user equipment (UE), the method comprising:
at the host, receiving user data transmitted to the host via the network node by the UE, wherein the UE performs any of example embodiments 1-12 to transmit the user data to the host.

45. The method of the previous embodiment, further comprising:
at the host, executing a host application associated with a client application executing on the UE to receive the user data from the UE.

46. The method of the previous 2 embodiments, further comprising:
at the host, transmitting input data to the client application executing on the UE, the input data being provided by executing the host application,
wherein the user data is provided by the client application in response to the input data from the host application.

Some abbreviations:

| Abbreviation | Explanation |
|---|---|
| CE | Control element |
| CORESET | Control resource set |
| CP | Cyclic prefix Control Plane |
| CSI | Channel state information |
| CSI-RS | Channel state information reference signals |
| DCI | Downlink control information |
| DL | Downlink |
| DM-RS | Demodulation reference signals |
| DPS | Dynamic point selection |
| DRX | Discontinuous reception |
| FR1 | Frequency range 1 |
| FR2 | Frequency range 2 |
| gNB | Next generation Node B |
| HST | High speed train |
| L1-RSRP | Layer 1 RSRP |
| LCID | Logical channel ID |
| MAC | Medium access control |
| MAC CE | MAC Control Element |
| NACK | Not acknowledged |
| NR | New radio |
| N_{TA} | TA (Timing Advance) adjustment |
| PBCH | Physical broadcast channel |
| PCell | Primary Cell |
| PDCCH | Physical downlink control channel |
| PDSCH | Physical downlink shared channel |
| PRS | Positioning reference signal |
| PSCell | Primary Secondary Cell Group (SCG) Cell |
| PSS | Primary synchronization signal |
| PUCCH | Physical uplink control channel |
| PUSCH | Physical uplink shared channel |
| RACH | Random access channel |
| RAT | Radio access technology |
| RRC | Radio resource control |
| RRH | Remote Radiohead |
| RRM | Radio resource management |
| RS | Reference signal |
| RSRP | Reference Signal Received Power |
| RSRQ | Reference Signal Received Quality |
| RX | Receive |
| SINR | Signal to Interference & Noise Ratio |
| SRS | Sounding Reference Signal |
| SS | Synchronization Signal |
| SSB | SS/PBCH block |
| SSS | Secondary synchronization signal |
| TA | Timing advance |
| TCI | Transmission configuration indicator |
| Te | UL timing error limit value |
| Tq | Maximum autonomous time adjustment step |
| TRP or TRxP | Transmission Reception Point/ |
| | Transmission and Reception Point |
| TX | Transmit |
| UE | User equipment |
| UL | Uplink |

1-23. (canceled)

24. A method, in a user equipment (UE), for adjusting timing with respect to a serving cell in a wireless network, the method comprising:
receiving from the wireless network, in or associated with a message or command changing an active configuration of the UE, an indication of whether the change in active configuration of the UE corresponds to one or both of (i) a change in Remote Radio Head (RRH) or transmission point(s) (TRPs) for transmissions from the wireless network to the UE and (ii) a change in uplink (UL) transmit timing and/or timing advance (TA) for the UE that exceeds the UE's capability to track with gradual timing adjustment procedures specified for the UE; and
performing one or more timing-adjustment operations, based on the indication.

25. The method of claim 24, wherein the message or command is a message or command changing a Transmission Configuration Indication (TCI) state for the UE.

26. The method of claim 25, wherein the indication is included in an Medium Access Control Control Element (MAC CE) changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

27. The method of claim 25, wherein the one or more timing-adjustment operations comprises performing an autonomous one-shot UL timing adjustment or a random access (RA) procedure in response to the indication indicating that the target TCI state belongs to a different RRH or TRP(s) from the RRH or TRP(s) for the previous TCI state and/or indicating that a change in UL transmit timing and/or TA associated with the target TCI state exceeds the UE's capability to track with gradual timing adjustment procedures specified for the UE.

28. The method of claim 25, wherein the one or more timing-adjustment operations comprises performing gradual timing adjustment procedures specified for the UE in response to the indication indicating that the target TCI state belongs to the same RRH or TRP(s) as the RRH or TRP(s) for the previous TCI state and/or indicating that a change in UL transmit timing and/or TA associated with the target TCI state is within the UE's capability to track with gradual timing adjustment procedures specified for the UE.

29. A method, in a network node, for assisting a user equipment (UE) to adjust timing with respect to a serving cell in a wireless network, the method comprising:
determining whether a message or command to be sent to the UE to change an active configuration of the UE corresponds to one or both of (i) a change in Remote Radio Head (RRH) or transmission point(s) (TRPs) for transmissions from the wireless network to the UE and (ii) a change in uplink (UL) transmit timing and/or timing advance (TA) for the UE that exceeds the UE's capability to track with gradual timing adjustment procedures specified for the UE; and,
sending an indication to the UE in or in association with the message or command, based on said determining.

30. The method of claim 29, wherein the message or command is a message or command changing a Transmission Configuration Indication (TCI) state for the UE.

31. The method of claim 30, wherein sending the indication comprises including the indication in an Medium Access Control Control Element (MAC CE) changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

32. A user equipment (UE) for adjusting timing with respect to a serving cell in a wireless network, the user equipment comprising communication interface circuitry configured to communicate with the wireless network and processing circuitry operatively coupled to the communication interface circuitry, the processing circuitry being configured to control the communication interface circuitry and to:
receive from the wireless network, in or associated with a message or command changing an active configuration of the UE, an indication of whether the change in active configuration of the UE corresponds to one or both of (i) a change in Remote Radio Head (RRH) or transmission point(s) (TRPs) for transmissions from the wireless network to the UE and (ii) a change in uplink (UL) transmit timing and/or timing advance (TA) for the UE that exceeds the UE's capability to track with gradual timing adjustment procedures specified for the UE; and
perform one or more timing-adjustment operations, based on the indication.

33. The UE of claim 32, wherein the message or command is a message or command changing a Transmission Configuration Indication (TCI) state for the UE.

34. The UE of claim 33, wherein the indication is included in an Medium Access Contro, Control Element (MAC CE) changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.

35. The UE of claim 33, wherein the one or more timing-adjustment operations comprises performing an autonomous one-shot UL timing adjustment or a random access (RA) procedure in response to the indication indicating that the target TCI state belongs to a different RRH or TRP(s) from the RRH or TRP(s) for the previous TCI state and/or indicating that a change in UL transmit timing and/or TA associated with the target TCI state exceeds the UE's capability to track with gradual timing adjustment procedures specified for the UE.

36. The UE of claim 33, wherein the one or more timing-adjustment operations comprises performing gradual timing adjustment procedures specified for the UE in response to the indication indicating that the target TCI state belongs to the same RRH or TRP(s) as the RRH or TRP(s) for the previous TCI state and/or indicating that a change in UL transmit timing and/or TA associated with the target TCI state is within the UE's capability to track with gradual timing adjustment procedures specified for the UE.

37. A network node for assisting a user equipment (UE) to adjust timing with respect to a serving cell in a wireless network, the network node comprising communication interface circuitry configured to communicate with the UE and processing circuitry operatively coupled to the communication interface circuitry, the processing circuitry being configured to control the communication interface circuitry and to:
determine whether a message or command to be sent to the UE to change an active configuration of the UE corresponds to one or both of (i) a change in Remote Radio Head (RRH) or transmission point(s) (TRPs) for transmissions from the wireless network to the UE and (ii) a change in uplink (UL) transmit timing and/or timing advance (TA) for the UE that exceeds the UE's capability to track with gradual timing adjustment procedures specified for the UE; and,
send an indication to the UE in or in association with the message or command, based on said determining.

38. The network node of claim 37, wherein the message or command is a message or command changing a Transmission Configuration Indication (TCI) state for the UE.

39. The network node of claim 38, wherein sending the indication comprises including the indication in an Medium Access Control Control Element (MAC CE) changing the TCI state for the UE, and wherein the indication indicates whether a target TCI state belongs to a different RRH or TRP(s) from the RRH or TRP(s) for a previous TCI state and/or indicates whether a change in UL transmit timing and/or TA associated with the target TCI state exceeds the UE's capability to track with gradual timing adjustment procedures specified for the UE.
